(19) United States
(12) Patent Application Publication
(10) Pub. No.: US 2025/0281836 A1
(43) Pub. Date: Sep. 11, 2025

(54) METHOD AND APPARATUS FOR INTERACTION WITH NON-PLAYER CHARACTER, DEVICE, STORAGE MEDIUM, AND PRODUCT

(71) Applicant: Tencent Technology (Shenzhen) Company Limited, Shenzhen (CN)

(72) Inventor: Liang ZHANG, Shenzhen (CN)

(21) Appl. No.: 19/220,832

(22) Filed: May 28, 2025

Related U.S. Application Data
(63) Continuation of application No. PCT/CN2024/080910, filed on Mar. 11, 2024.

(30) Foreign Application Priority Data
May 6, 2023 (CN) 202310509210.2

(51) Int. Cl. A63F 13/537

(52) U.S. Cl. CPC A63F 13/537

(57) ABSTRACT

This application discloses a method for performing interaction with a non-player character performed by a computer device. The method includes: displaying a game interaction interface, the game interaction interface including a virtual character and at least one non-player character (NPC); determining an identity association relationship between the virtual character and the NPC in response to an interactive operation between the virtual character and the NPC, the identity association relationship being configured for indicating an association relationship between the virtual character and the NPC in terms of interactive identity; and displaying an interactive activity between the NPC and the virtual character based on the identity association relationship. By the foregoing method, the NPC can actively change the interactive activity between the NPC and the virtual character based on the identity association relationship, so that the interactive activity between the NPC and the virtual character is richer and more real.

### CROSS-REFERENCE TO RELATED APPLICATIONS

This application is a continuation application of PCT Patent Application No. PCT/CN2024/080910, entitled “METHOD AND APPARATUS FOR INTERACTION WITH NON-PLAYER CHARACTER, DEVICE, STORAGE MEDIUM, AND PRODUCT” filed on Mar. 11, 2024, which claims priority to Chinese Patent Application No. 202310509210.2, entitled “METHOD AND APPARATUS FOR INTERACTION WITH NON-PLAYER CHARACTER, DEVICE, STORAGE MEDIUM, AND PRODUCT” and filed on May 6, 2023, both of which are incorporated herein by reference in their entirety.

### FIELD OF THE TECHNOLOGY

Embodiments of this application relate to the field of human-computer interaction technologies, and in particular, to a method and apparatus for interaction with a non-player character, a device, a storage medium, and a product.

### BACKGROUND OF THE DISCLOSURE

In an application program based on a virtual environment, for example, a massively multiplayer online game (MMOG), a user may control a virtual character to move in the virtual environment. In addition, a non-player character (NPC) further exists in the virtual environment. The NPC may interact with the virtual character controlled by the user, for example, attack the virtual character controlled by the user, or the NPC can drive a plot attached to a task or help the user to complete a task, or the NPC converses with the virtual character.

In a related technology, a virtual character interacts with an NPC by using preset interaction logic. That is, a behavior of the virtual character is used as an input to calculate interactive content that needs to be made by the NPC, and the interactive content is used as an output. For example, the virtual character poses a question to the NPC, and the NPC makes an answer based on the question, thereby completing the interaction.

However, in the related technology, an interactive mode between the NPC and the virtual character is relatively fixed, the NPC can only interact, based on preset interaction logic, with the virtual character controlled by a user, and the NPC has relatively low intelligence.

### SUMMARY

This application provides a method and apparatus for interaction with a non-player character, a device, a storage medium, and a product. The technical solutions are as follows:

According to an aspect of this application, a method for performing interaction with a non-player character is performed by a computer device, the method including:
displaying a game interaction interface, the game interaction interface including a virtual character and at least one non-player character (NPC);
determining an identity association relationship between the virtual character and the NPC in response to an interactive operation between the virtual character and the NPC, the identity association relationship being configured for indicating an association relationship between the virtual character and the NPC in terms of interactive identity; and
displaying an interactive activity between the NPC and the virtual character based on the identity association relationship.

According to an aspect of this application, a method for performing interaction with a non-player character is performed by a server, the method including:
transmitting data related to a game interaction interface to a terminal, the game interaction interface including a virtual character and at least one non-player character (NPC);
determining an identity association relationship between the virtual character and the NPC based on an interactive operation between the virtual character and the NPC, the identity association relationship being configured for indicating an association relationship between the virtual character and the NPC in terms of interactive identity; and
controlling an interactive activity between the NPC and the virtual character based on the identity association relationship.

According to another aspect of this application, a computer device is provided, the computer device including: a processor and a memory, the memory having at least one computer program stored therein, and the at least one computer program, when loaded and executed by the processor, causing the computer device to implement the method for performing interaction with a non-player character according to each aspect as described above.

According to another aspect of this application, a non-transitory computer storage medium is provided, the computer-readable storage medium having at least one computer program stored therein, and the at least one computer program, when loaded and executed by a processor of a computer device, causing the computer device to implement the method for performing interaction with a non-player character according to each aspect as described above.

The technical solutions provided in this application have at least the following beneficial effects.

In this application, the identity association relationship between the virtual character and the NPC is displayed, so that the NPC can display an interactive activity between the NPC and the virtual character based on the identity association relationship, and the interactive activity between the NPC and the virtual character is richer and more real. Therefore, a behavior of the NPC is closer to a virtual character controlled by a real user, thereby improving user experience.

### BRIEF DESCRIPTION OF THE DRAWINGS

FIG. 1 is a schematic diagram of a method for performing interaction with a non-player character according to an exemplary embodiment of this application;

FIG. 2 is a schematic architectural diagram of a computer system according to an exemplary embodiment of this application;

FIG. 3 is a flowchart of a method for performing interaction with a non-player character according to an exemplary embodiment of this application;

FIG. 4 is a flowchart of a method for performing interaction with a non-player character according to an exemplary embodiment of this application;

FIG. 5 is a schematic diagram of an entry interface for selecting an NPC to be interacted with according to an exemplary embodiment of this application;

FIG. 6 is a diagram of an interface for selecting an NPC to be interacted with according to an exemplary embodiment of this application;

FIG. 7 is a schematic diagram of an interface of NPC information according to an exemplary embodiment of this application;

FIG. 8 is a schematic diagram of an interface for giving a gift to an NPC by a virtual character according to an exemplary embodiment of this application;

FIG. 9 is a schematic diagram of an interface for selecting an identity association relationship according to an exemplary embodiment of this application;

FIG. 10 is a schematic diagram of an interface for selecting an interaction topic according to an exemplary embodiment of this application;

FIG. 11 is a schematic diagram of an interface for NPC interaction permission settings according to an exemplary embodiment of this application;

FIG. 12 is a schematic diagram of an interface for dissolving an identity association relationship between a virtual character and an NPC according to an exemplary embodiment of this application;

FIG. 13 is a flowchart of a method for performing interaction with a non-player character according to an exemplary embodiment of this application;

FIG. 14 is a block diagram of an apparatus for interaction with a non-player character according to an exemplary embodiment of this application;

FIG. 15 is a block diagram of an apparatus for interaction with a non-player character according to an exemplary embodiment of this application; and

FIG. 16 is a schematic structural diagram of a computer device according to an exemplary embodiment of this application.

### DESCRIPTION OF EMBODIMENTS

First, terms involved in the embodiments of this application are described.

Virtual environment: This is a virtual environment displayed (or provided) when an application program runs on a terminal. The virtual environment may be a simulated environment of the real world, or may be a semi-simulated and semi-fictional environment, or may be an entirely fictional environment. The virtual environment may be any one of a two-dimensional virtual environment, a 2.5-dimensional virtual environment, and a three-dimensional virtual environment. This is not limited in this application. The following embodiments are described by using an example in which the virtual environment is a three-dimensional virtual environment.

Virtual character: This refers to a movable character in a virtual environment. The movable character may be a virtual human, a virtual animal, a cartoon character, or the like, for example, a human, an animal, a plant, a wall, a stone or a water pool displayed in the virtual environment. Virtual characters are controlled by a user, and the virtual characters may be classified based on jobs into, for example, pharmacists, magicians, or therapists. The virtual characters may alternatively be classified based on categories into, for example, humans, beasts, and immortals. Each virtual character has a shape and a volume in the virtual environment, and occupies part of space in the virtual environment.

Massively multiplayer online game (MMOG): This refers to a game in which a server of the game enables a large number of players to be online at the same time, and is also named a massive multiplayer online role-playing game (MMORPG). The game provides a virtual world for a user. In the game, the user may create a virtual character, and control the virtual character to perform a corresponding activity, to complete a task corresponding to the activity. Virtual characters controlled by a plurality of users may form a team, to complete the same task together, or to battle against other teams.

Non-player character (NPC): This refers to a virtual character in a game that is not controlled by a user, is generally controlled by artificial intelligence of a computer, and is a virtual character that may have a behavior mode of the virtual character. NPC types include: a plot NPC, a combat NPC, a service NPC, and the like. The plot NPC is an NPC that provides story plots or information for a virtual character controlled by a user. When the virtual character controlled by the user executes a task in a game, the task is attached with a corresponding story plot. In some embodiments, the NPC may provide different feedbacks based on communication information or actions between the user and the plot NPC, for example, drop a virtual prop, provide prompt information, and release a new task. The battle NPC is an NPC that may battle with a virtual character controlled by a user, and the battle NPC may be a virtual character that belongs to the same team as the virtual character controlled by the user, or an NPC (that is, an enemy NPC) that the virtual character controlled by the user needs to attack. The service NPC is an NPC providing a service for a virtual character controlled by a user. For example, the service NPC is a merchant virtual character, a training virtual character, or the like in a virtual environment. In some embodiments, Such an NPC performs a fixed action or releases fixed information, and the virtual character controlled by the user receives a service of the service NPC, and obtains corresponding information, props, empirical values, and the like.

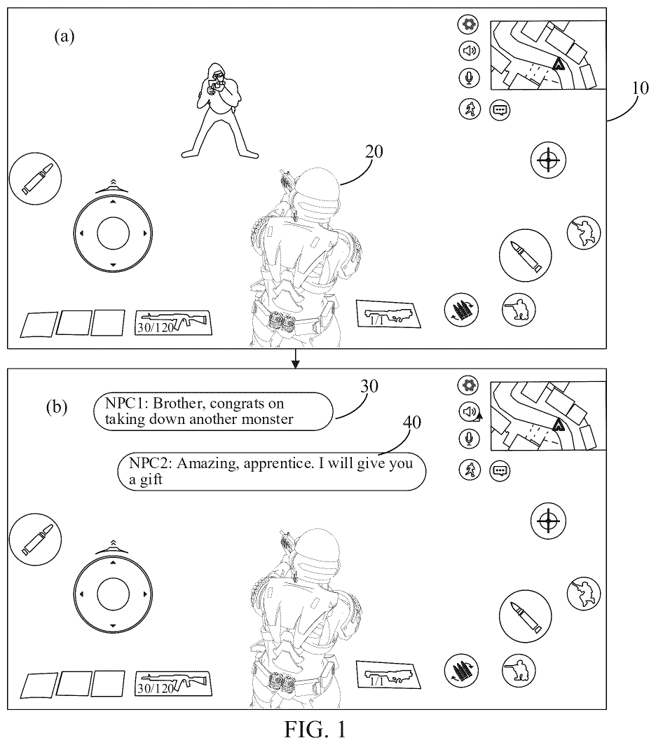

An embodiment of this application provides a schematic diagram of a method for performing interaction with a non-player character. As shown in FIG. 1, the method may be performed by a computer device, and the computer device may be a terminal or a server.

For example, as shown in FIG. (a) in FIG. 1, a game interaction interface 10 is displayed on a user interface. The game interaction interface 10 includes a virtual character 20 and at least one NPC. The computer device determines an identity association relationship between the virtual character 20 and the NPC in response to an interactive operation between the virtual character 20 and the NPC; and the computer device controls the NPC to change an interactive activity between the NPC and the virtual character 20 based on the identity association relationship. In some embodiments, The NPC has a specific image, or the NPC has no specific image. In an example in which the NPC has no specific image, the NPC may converse, give a gift to, or consult a problem with the virtual character 20 in a form of a dialog box. For example, after the virtual character 20 wins, the NPC transmits greetings to the virtual character 20. In an example in which the NPC has a specific image, the NPC may be an NPC having a human image, or an NPC having an animal image, or an NPC having a mythical creature image or a fairy image, or the NPC is an NPC having a natural landscape image, or an NPC having an artificial landscape image.

The identity association relationship is configured for indicating an association relationship between the virtual character 20 and the NPC in terms of identity. In some embodiments, the identity association relationship includes at least one of a lover relationship, a confidant relationship, a playmate relationship, and a mentoring relationship, but is not limited thereto. This is not specifically limited in the embodiment of this application. For example, the computer device determines a favorability value between the virtual character 20 and the NPC based on the interactive operation between the virtual character 20 and the NPC; and the computer device determines the identity association relationship between the virtual character 20 and the NPC based on the favorability value. In some embodiments, the interactive operation includes at least one of typing chat, voice chat, gift giving, and daily greeting, but is not limited thereto. This is not specifically limited in the embodiment of this application. For example, the computer device increases the favorability value between the virtual character 20 and the NPC based on the interactive operation, and determines, when that the favorability value is greater than a first threshold, that the identity association relationship between the virtual character 20 and the NPC is a “playmate relationship”, or determines, when that the favorability value is greater than a second threshold, that the identity association relationship between the virtual character 20 and the NPC is a “mentoring relationship”.

After determining the identity association relationship between the virtual character 20 and the NPC, the computer device controls the NPC to change at least one of an interactive mode and interactive content between the NPC and the virtual character 20. In some embodiments, the computer device controls the NPC to actively interact with the virtual character 20 as an interaction initiator. For example, the NPC actively cares about the virtual character 20 as a lover.

In some embodiments, the computer device controls the NPC to transmit interactive content belonging to the identity association relationship to the virtual character 20 based on an identity of the NPC in the identity association relationship. That is, the interactive content transmitted by the NPC is expressed in a tone or emotion of the identity in the identity association relationship.

The virtual character 20 may have a plurality of NPCs having different identity association relationships, and each NPC corresponds to an interaction topic. That is, the same thing has different responses to NPCs having different identity association relationships, and the same thing also has different responses to the same NPC having an interaction topic and the same NPC having no interaction topic. As shown in FIG. (b) in FIG. 1, after the virtual character 20 defeats a monster, an NPC1 having a “playmate relationship” with the virtual character 20 actively transmits first interaction information 30 to the virtual character: “Brother, congrats on taking down another monster”, and an NPC2 having a “mentoring relationship” with the virtual character 20 actively transmits second interaction information 40 to the virtual character: “Amazing, apprentice. I will give you a gift”.

In some embodiments, after the identity association relationship between the virtual character 20 and the NPC is determined, an interaction topic may be selected between the virtual character 20 and the NPC, so that a conversation between the NPC and the virtual character 20 is no longer talking in general terms, but a conversation is performed around the interaction topic.

For example, it is determined that the identity association relationship between the virtual character 20 and the NPC is a “lover relationship”. When no interaction topic is selected, the virtual character 20 and the NPC may chat as lovers without being specifically limited. After an interaction topic “feelings” is selected, the virtual character 20 and the NPC talk about a “feelings” topic as lovers, and no longer talk about other topics.

To sum up, in the method according to this embodiment, a game interaction interface is displayed, the game interaction interface including a virtual character and at least one non-player character (NPC); an identity association relationship between the virtual character and the NPC is determined in response to an interactive operation between the virtual character and the NPC; and the NPC is controlled to change an interactive activity between the NPC and the virtual character based on the identity association relationship. In this application, the identity association relationship between the virtual character and the NPC is determined, so that the NPC can change an interactive activity between the NPC and the virtual character based on the identity association relationship, and the interactive activity between the NPC and the virtual character is richer and more real. Therefore, that a behavior of the NPC is closer to a virtual character controlled by a real user, thereby improving user experience.

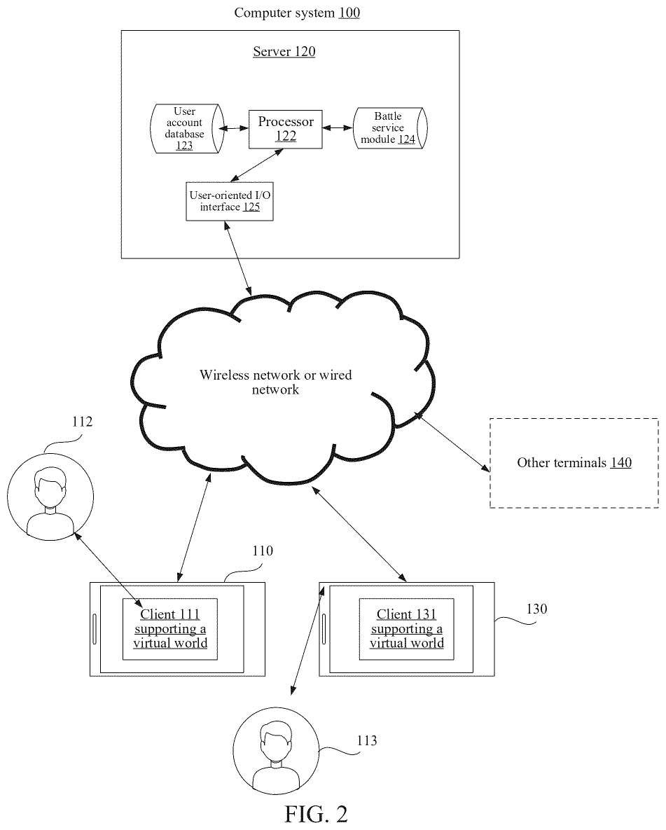

FIG. 2 is a structural block diagram of a computer system according to an exemplary embodiment of this application. The computer system 100 includes: a first terminal 110, a server 120, and a second terminal 130.

A client 111 supporting a virtual environment is installed and runs in the first terminal 110. The client 111 may be a multiplayer online battle program. When the first terminal runs the client 111, a user interface of the client 111 is displayed on the screen of the first terminal 110. The client 111 may be any one of a massively multiplayer online game (MMOG), a battle Royale shooting game, a virtual reality (VR) application program, an augmented reality (AR) program, a three-dimensional map program, a virtual reality game, an augmented reality game, a first-person shooter (FPS) game, a third-person shooter (TPS) game, a multiplayer online battle arena (MOBA) game, and a simulation game (SLG). In this embodiment, an example in which the client 111 is an MMOG is used for description. The first terminal 110 is a terminal used by a first user 112. The first user 112 uses the first terminal 110 to control a first virtual character located in a virtual environment to perform activities, or operate virtual goods owned by a second virtual character, and the first virtual character may be referred to as a virtual character of the first user 112. The first user 112 may perform operations such as assembly, disassembly, and uninstallation on virtual goods owned by the first virtual character. This is not limited in this application. Schematically, the first virtual character is a first virtual character, for example, a simulated character or a cartoon character.

A client 131 supporting a virtual environment is installed and runs in the second terminal 130. The client 131 may be a multiplayer online battle program. When the second terminal 130 runs the client 131, a user interface of the client 131 is displayed on a screen of the second terminal 130. The client may be any one of an MMOG, a battle Royale shooting game, a VR application program, an AR program, a three-dimensional map program, a virtual reality game, an augmented reality game, an FPS, a TPS, an MOBA, and an SLG. In this embodiment, an example in which the client is an MMOG is used for description. The second terminal 130 is a terminal used by a second user 113. The second user 113 uses the second terminal 130 to control a second virtual character located in the virtual environment to perform activities and operate virtual goods owned by the second virtual character, and the second virtual character may be referred to as a virtual character of the second user 113. Schematically, the second virtual character is a second virtual character, for example, a simulated character or a cartoon character.

In some embodiments, the first virtual character and the second virtual character are in the same virtual environment. In some embodiments, the first virtual character and the second virtual character may belong to the same camp, the same team, the same organization, have a friend relationship, or have temporary communication permissions. In some embodiments, the first virtual character and the second virtual character may belong to different camps, different teams, or different organizations, or have a hostile relationship with each other. In some embodiments, the clients installed on the first terminal 110 and the second terminal 130 are the same, or the clients installed on the two terminals are the same type of clients on different operating system platforms (Android or IOS). The first terminal 110 may generally refer to one of a plurality of terminals, and the second terminal 130 may generally refer to another one of the plurality of terminals. In this embodiment, only the first terminal 110 and the second terminal 130 are used as an example for description. Device types of the first terminal 110 and the second terminal 130 are the same or different. The device types include: at least one of a smartphone, a tablet computer, an e-book reader, a moving picture experts group audio layer III (MP3) player, a moving picture experts group audio layer IV (MP4) player, a laptop portable computer, and a desktop computer.

Only two terminals are shown in FIG. 2, but in different embodiments, there are a plurality of other terminals 140 that can access the server 120. In some embodiments, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal 110 and the second terminal 130 may download the client installation package from the server 120 to update the client.

The first terminal 110, the second terminal 130, and the other terminals 140 are connected to the server 120 through the wired or wireless network. The server 120 includes at least one of one server, a plurality of servers, a cloud computing platform, and a virtualization center. The server 120 is configured to provide a background service for a client that supports a three-dimensional virtual environment. In some embodiments, the server 120 undertakes main computing work and the terminal undertakes secondary computing work; or the server 120 undertakes secondary computing work and the terminal undertakes main computing work; or a distributed computing architecture is used between the server 120 and the terminal to perform collaborative computing.

In a schematic example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, such as head portraits of the user accounts, nicknames of the user accounts, battle strength indexes of the user accounts, and service areas of the user accounts. The battle service module 124 is configured to provide a plurality of battle rooms for the users to battle, for example, a 1V1 battle room, a 3V3 battle room, and a 5V5 battle room. The user-oriented I/O interface 125 is configured to establish communication and exchange data with the first terminal 110 and/or the second terminal 130 through a wireless network or a wired network.

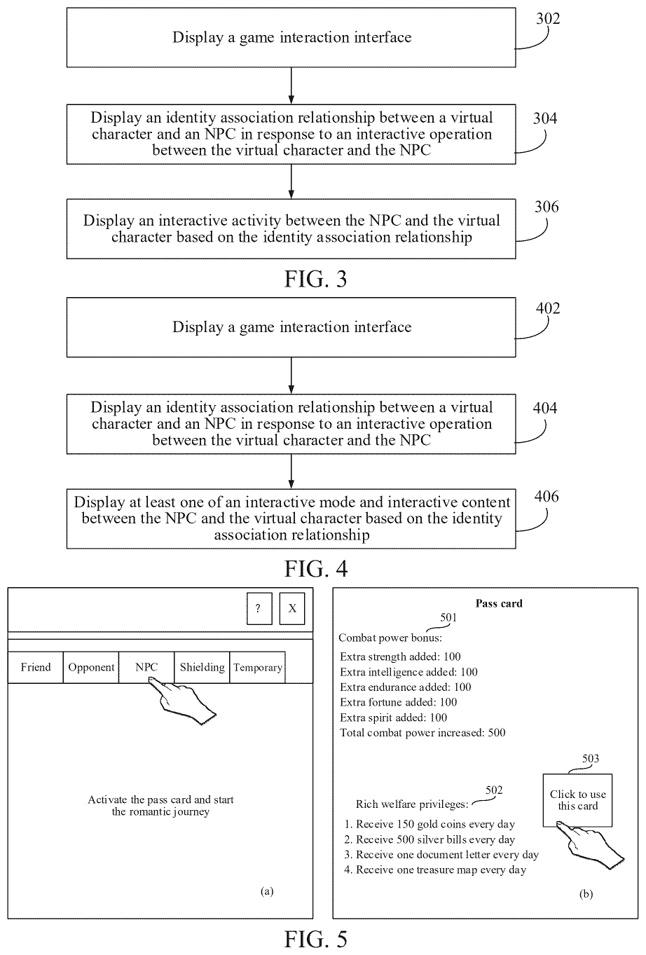

FIG. 3 is a flowchart of a method for performing interaction with a non-player character according to an exemplary embodiment of this application. This method can be performed by a computer device, and the computer device may be the terminal 100 in FIG. 2. The method includes the following operations:

Operation 302: Display a game interaction interface.

The game interaction interface refers to an interface through which a virtual character controlled by a user interacts with an NPC.

The game interaction interface includes a virtual character and at least one NPC.

In some embodiments, the NPC has a specific image. When a virtual object interacts with the NPC, a head portrait or a two-dimensional or three-dimensional avatar of the NPC is displayed. Alternatively, the NPC has no specific image, and interacts with the virtual character in a text or multimedia information mode.

In an example in which the NPC has no specific image, the NPC may converse, present a gift to, or consult a problem with the virtual character in a form of a dialog box, but is not limited thereto. This is not specifically limited in the embodiment of this application.

In an example in which the NPC has a specific image, the NPC may be an NPC having a human image, or an NPC having an animal image, or an NPC having a mythical creature image or a fairy image fictitious in a virtual environment, or the NPC is an NPC having a natural landscape image (for example, the NPC is trees in appearance), or an NPC having an artificial landscape image (for example, the NPC is an aircraft or a ship in appearance, or a human image having the foregoing item elements), but is not limited thereto. This is not specifically limited in the embodiment of this application.

Operation 304: Display an identity association relationship between the virtual character and the NPC in response to an interactive operation between the virtual character and the NPC.

For example, the interactive operation may be an operation of unidirectional or bidirectional communication between the virtual character and the NPC in the virtual environment. For example, the interactive operation includes at least one of typing chatting, voice chatting, video chatting, gift giving or receiving, daily greetings, and playing of a plot animation, but is not limited to. This is not specifically limited in the embodiment of this application. The interactive operation may alternatively be an operation of controlling the virtual character to set an NPC. For example, the interactive operation is an operation of setting an NPC identity association relationship. Correspondingly, the interactive operation is received by a terminal, for example, a control terminal of the virtual character.

The identity association relationship is configured for indicating an association relationship between the virtual character and the NPC in terms of interactive identity.

In some embodiments, the identity association relationship includes at least one of a lover relationship, a confidant relationship, a playmate relationship, and a mentoring relationship, but is not limited thereto. This is not specifically limited in the embodiment of this application.

Operation 306: Display an interactive activity between the NPC and the virtual character based on the identity association relationship.

For example, after the identity association relationship between the virtual character and the NPC is determined, an interactive activity between the NPC and the virtual character is controlled by a server, and the server provides a background service for a game to which the game interaction interface belongs.

In some embodiments, the interactive activity includes an interactive mode and interactive content. The interactive mode is an initiating form when the virtual character interacts with the NPC, for example, which one serves as an interaction initiator during interaction. The interactive mode refers to an interaction form when the virtual character interacts with the NPC, and the interaction form includes at least one of text interaction, voice interaction, and emoji interaction, but is not limited thereto.

The interactive content is content when the virtual character interacts with the NPC. In some embodiments, the interactive content includes at least one of an identity appellation, a modal particle, an active sentence, a passive sentence, and a topic range, but is not limited thereto. For example, there is a one-to-one correspondence mapping relationship between the identity association relationship and the interactive activity. Before the identity association relationship is determined between the virtual character and the NPC, the NPC does not actively interact with the virtual character, and interactive content is preset interaction logic, for example, a preset interaction conversation, which is relatively uniform. After the identity association relationship between the virtual character and the NPC is determined, and after the virtual character defeats a monster, an NPC1 having a “playmate relationship” with the virtual character actively transmits first interaction information to the virtual character: “Brother, congrats on taking down another monster”, and an NPC2 having a “mentoring relationship” with the virtual character actively transmits second interaction information to the virtual character: “Amazing, apprentice. I will give you a gift”. That is, an NPC having an identity association relationship can actively initiate an interaction, and NPCs having different identity association relationships can perform different interactions for the same event.

To sum up, in the method according to this embodiment, in this application, the identity association relationship between the virtual character and the NPC is displayed, so that the NPC can display an interactive activity between the NPC and the virtual character based on the identity association relationship, and the interactive activity between the NPC and the virtual character is richer and more real. Therefore, a behavior of the NPC is closer to a virtual character controlled by a real user, thereby improving user experience.

FIG. 4 is a flowchart of a method for performing interaction with a non-player character according to an exemplary embodiment of this application. This method can be performed by a computer device, and the computer device may be the terminal 100 in FIG. 2. The method includes the following operations:

Operation 402: Display a game interaction interface.

The game interaction interface refers to an interface through which a virtual character controlled by a user interacts with an NPC. The game interaction interface includes a virtual character and at least one NPC. For example, FIG. 5 is a schematic diagram of an entry interface for selecting an NPC to be interacted with. As shown in FIG. (a) in FIG. 5, to interact with an NPC (which may also be referred to as obtaining romance associated with an NPC), a pass card needs to be obtained and activated before the playing method is activated. The romance refers to an identity relationship established between a virtual character and an NPC. Content of the pass card is shown in FIG. (b) in FIG. 5. First information 501 is configured for indicating virtual combat force bonus information of the foregoing pass card for performing a virtual competition in a virtual environment, and second information 502 is configured for indicating welfare privileges brought by the pass card, including a type and a number of virtual goods for which the virtual object has a collection permission. The pass card is activated by clicking the activation control 503, so that the virtual character can interact with the NPC.

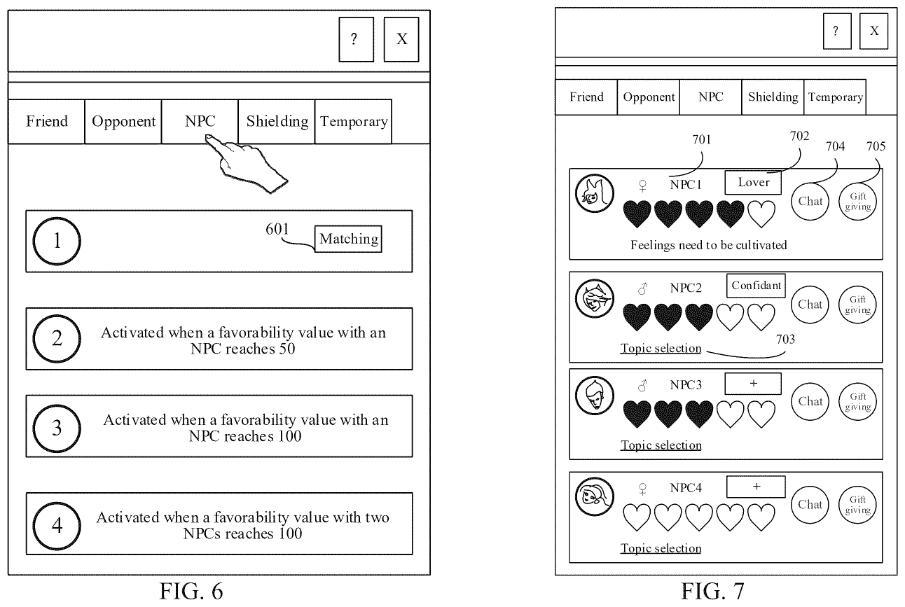

FIG. 6 is a diagram of an interface for selecting an NPC to be interacted with. The interface for selecting an NPC to be interacted with includes four NPC positions. That is, a virtual character may interact with four NPCs. The first NPC is started by default. A “Matching” control 601 is triggered to match the virtual character with an NPC. The “Matching” control is configured to randomly match the virtual character with an NPC (for example, randomly extract an NPC from a preset NPC pool). After an NPC is matched, there is no identity association relationship between the virtual character and the NPC (for example, before operation 404 is performed, the identity association relationship between the virtual character and the NPC is null). The other three NPC positions need to satisfy a certain condition to be unlocked, and only after the NPC positions are unlocked can NPCs be matched. The “matching” herein is to simulate initial acquaintance in real life. That is, after an NPC position is unlocked, the virtual character may know a new NPC through matching, to simulate an interaction process between new friends in the real world, such as adding a friend relationship in a social application and leaving a phone number. An unlocking condition for the second NPC position is: a favorability value with an NPC reaches 50; an unlocking condition for the third NPC position is: a favorability value with an NPC reaches 100; and an unlocking condition for the fourth NPC position is: a favorability value with two NPCs reaches 100. Different unlocking conditions are set, and the unlocking conditions progress layer by layer, thereby promoting interaction between the virtual character and the NPC, and improving user experience. In addition, in the embodiment of this application, four NPC positions are set, but the embodiment is not limited thereto. When that all the four NPC positions are unlocked, the virtual character may interact with a plurality of NPCs at the same time, so that a relationship between the virtual character and the NPCs is closer to a relationship with a plurality of friends in real life, and the interaction between the virtual character and the NPCs is more real.

Operation 404: Display an identity association relationship between the virtual character and the NPC in response to an interactive operation between the virtual character and the NPC.

The interactive operation includes at least one of typing chat, voice chat, gift giving, and daily greeting, but is not limited thereto. This is not specifically limited in the embodiment of this application. The identity association relationship is configured for indicating an association relationship between the virtual character and the NPC in terms of identity. In some embodiments, the identity association relationship includes at least one of a lover relationship, a confidant relationship, a playmate relationship, and a mentoring relationship, but is not limited thereto. This is not specifically limited in the embodiment of this application.

For example, the computer device changes and displays a favorability value between the virtual character and the NPC based on the interactive operation between the virtual character and the NPC; and the computer device displays an identity association relationship between the virtual character and the NPC corresponding to the favorability value. Correspondingly, a server determines a favorability value between the virtual character and the NPC based on the interactive operation; and determines the identity association relationship between the virtual character and the NPC based on the favorability value. The favorability value and identity association relationship displayed by the computer device are displayed by the computer device as indicated by the server. In some embodiments, the computer device selects the identity association relationship between the virtual character and the NPC within an identity association relationship scope based on the favorability value.

In some embodiments, when that the favorability value between the virtual character and the NPC is greater than the first threshold, the computer device selects an identity association relationship within an identity association relationship scope of interest (for example, including a lover relationship and a playmate relationship, a total of two identity association relationships). When that the favorability value between the virtual character and the NPC is greater than the second threshold, the computer device selects an identity association relationship within a second identity association relationship scope (for example, including a lover relationship, a confidant relationship, a playmate relationship, and a mentoring relationship, a total of four identity association relationships). A number of identity association relationships within the second identity association relationship scope is greater than a number of identity association relationships within the identity association relationship scope of interest, and the second threshold is greater than the first threshold. This is to simulate a social law that in the real world, with the increase of a favorability value, social relations develop in diverse modes.

In this embodiment, only two identity association relationship scopes are used as an example, but the embodiment is not limited thereto.

The favorability value refers to an interaction score between a virtual character and an NPC. A favorability value only takes effect among NPCs matching a virtual character, and is irrelevant to an NPC of another virtual character. In some embodiments, the computer device may score an interactive activity between a virtual character and an NPC, to obtain a favorability value, or rank an activity event, to obtain a favorability value.

FIG. 7 is a schematic diagram of an interface of NPC information. Four NPC positions in the figure are matched with corresponding NPCs, and each NPC in the figure includes a name 701 of the NPC, a favorability value (indicated by a number of hearts), a topic selection control 703, an identity association relationship identifier 702, a chat control 704, and a gift giving control 705. The favorability value is configured for reflecting an interaction score between a virtual character and an NPC, and a larger number of hearts indicates a higher favorability value. An interaction topic between the virtual character and the NPC may be selected by triggering the topic selection control 703, and an identity association relationship between the virtual character and the NPC may be selected by triggering the identity association relationship identifier 702. Chatting with the NPC may be implemented by triggering the chat control 704, and giving a gift to the NPC may be implemented by triggering the gift giving control 705.

In some embodiments, an upper limit of the favorability value is 500 points, every 50 points denote half a heart, and one heart is denoted by 100 points.

For example, a method for increasing a favorability value includes at least one of the following, but is not limited to: the virtual character chats with an NPC having an identity association relationship; the virtual character gives a gift to an NPC having an identity association relationship; and an NPC actively gives a gift to the virtual character. In some embodiments, when a virtual character chats with an NPC having an identity association relationship, a set of dialogs increases a favorability value by one point, and each NPC can increase the favorability value by 5 points at most per day through chatting.

In some embodiments, when the virtual character gives a gift to an NPC having an identity association relationship, each NPC receives a gift twice at most per day, and favorability values corresponding to gifts may be the same or different.

When the favorability values corresponding to the gifts are different, the favorability values are in direct proportion to virtual values of the gifts.

In some embodiments, a scenario in which an NPC actively gives a gift to a virtual character includes at least one of the following:
When the virtual character logs in for the first time in a day/week/month, the NPC actively gives an opening gift to the virtual character. In some embodiments, the opening gift includes at least one of virtual clothes, a virtual prop, virtual gold coins, an empirical value, walkthrough, and gameplay tips, but is not limited thereto.
When a virtual character obtains a win in a battle, the NPC actively gives a congratulation gift to the virtual character.
When a virtual character fails in the battle, the NPC actively gives a comfort gift to the virtual character.

In some embodiments, the gift actively given by the NPC to the virtual character includes at least one of virtual clothes, a virtual prop, virtual gold coins, an empirical value, walkthrough, and gameplay tips, but is not limited thereto.

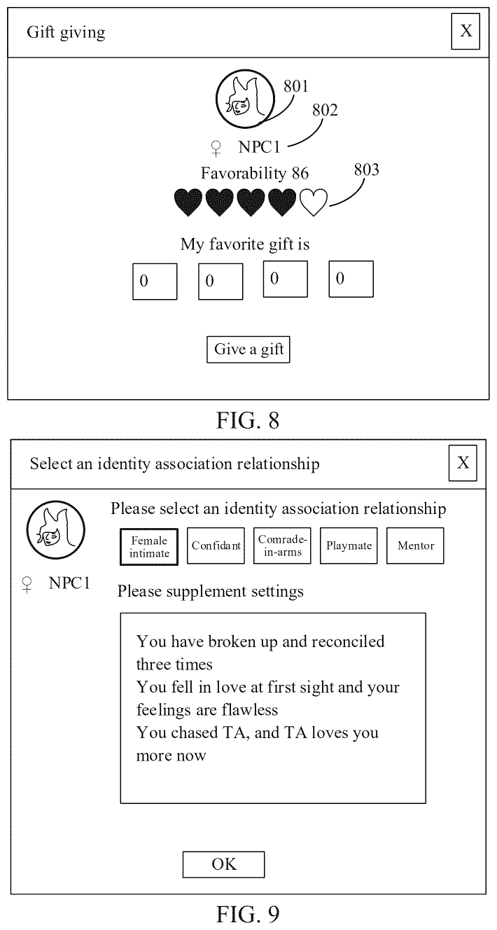

FIG. 8 is a schematic diagram of an interface for giving a gift to an NPC by a virtual character. Giving a gift to the NPC may be implemented by triggering a gift giving control. A head portrait 801 of the NPC, a name 802 of the NPC, and a favorability value 803 are displayed on the interface for giving a gift to the NPC. The gift given by the virtual character to the NPC is a virtual prop in a backpack of the virtual character. Virtual props are of different types and quality, and favorability values corresponding to the virtual props may also be different. The virtual character may select a virtual prop from the backpack and give the virtual prop to the NPC.

In some embodiments, there is an upper limit on the number of times the virtual character gives a gift to an NPC per day. For example, the virtual character can only give a gift to the NPC three times a day. Similarly, there is also an upper limit on the number of times an NPC gives a gift to a virtual character.

For example, a method for reducing the favorability value includes at least one of the following, but is not limited to: the virtual character does not chat with an NPC having an identity association relationship for more than a first number of days; the virtual character and an NPC having an identity association relationship do not give a gift for more than a first number of days; and the virtual character changes an identity association relationship between the virtual character and an NPC.

For example, when that the virtual character does not successfully converse with an NPC having an identity association relationship and does not receive any gift for more than three days, a three-point favorability value is deducted per day from the fourth day, and a greeting is actively transmitted to a user when the user goes online on the fourth day, to indicate a regret that the relationship is diminishing. If the virtual character has a plurality of NPCs having an identity association relationship, which are all in a favorability value deduction stage, only one NPC is randomly selected from the plurality of NPCs having an identity association relationship, to transmit a greeting to the user.

In some embodiments, an identity association relationship between the virtual character and the NPC is automatically dissolved when a favorability value between the virtual character and the NPC is less than a relationship dissolution threshold. For example, the relationship dissolution threshold is set to 10, and when the favorability value between the virtual character and the NPC is less than 10, the identity association relationship between the virtual character and the NPC is automatically dissolved.

For example, the computer device controls the NPC to interact with the virtual character in different emotions based on the favorability value.

In some embodiments, when there is a different favorability value between the NPC and the virtual character, the NPC also has a different emotion for the virtual character. In some embodiments, an emotion of an NPC may be implemented by at least one of a neural network model, a behavior tree, and a state machine. Schematically, the emotion of the NPC is implemented by the neural network model. In some embodiments, the neural network model is built in a server, or the neural network model is located in a client.

In some embodiments, the neural network model is built in a server. Human emotion data and corresponding activity data when emotions are generated, for example, emotions such as happiness, sadness, worry, fear, flurry, surprise, depression, and missing, and for example, activity events such as obtaining a reward, being hurt, not completing a task, meeting a bad guy, completing a task with high difficulty within a short time, failing a task, and missing a family member, are inputted to the neural network model, and the neural network model is trained through the data, to obtain a trained neural network model. When data of interactive activities corresponding to different favorability values is inputted into the neural network model, corresponding emotion data is outputted, so that the server can control the NPC to attach different emotions for different interactive activities.

For example, FIG. 9 is a schematic diagram of an interface for selecting an identity association relationship. When that a favorability value between a virtual character and an NPC meets a selection condition for an identity association relationship, the virtual character may select an identity association relationship between the virtual character and the NPC. The identity association relationships shown in the figure include a female intimate relationship, a confidant relationship, a comrade-in-arms relationship, a playmate relationship, and a mentor relationship. A mode of determining an identity association relationship option in the figure is determined based on a favorability value between a virtual character and an NPC, and attribute information of the virtual character and the NPC. That is, the computer device determines, based on the favorability value and the attribute information of the virtual character and the NPC, an identity association relationship within an identity association relationship scope for a user to select. For example, when that the virtual character and the NPC are of the same sex, a “brotherly relationship” or a “bosom female friend relationship” may be selected. When that the virtual character and the NPC are of opposite sex, a “female intimate relationship” or a “male intimate relationship” may be selected. In some embodiments, when that the identity association relationship does not meet an attribute requirement, an NPC needs to be reselected or an identity association relationship needs to be reselected. For example, a requirement for the “female intimate relationship” is the opposite sex. Therefore, if the same sex occurs, an NPC needs to be reselected or an identity association relationship needs to be reselected.

Operation 406: Display at least one of an interactive mode and interactive content between the NPC and the virtual character based on the identity association relationship.

Correspondingly, at least one of an interactive mode and interactive content between the NPC and the virtual character is controlled by the server based on the identity association relationship. The interactive mode is an initiating form when the virtual character interacts with the NPC, for example, which one serves as an interaction initiator during interaction. The interactive mode refers to an interaction form when the virtual character interacts with the NPC, and the interaction form includes at least one of text interaction, voice interaction, and emoji interaction, but is not limited thereto.

The interactive content is content when the virtual character interacts with the NPC. In some embodiments, the interactive content includes at least one of an identity appellation, a modal particle, an active sentence, a passive sentence, and a topic range, but is not limited thereto.

For example, the computer device displays that the NPC actively interacts with the virtual character as an interaction initiator. For example, when the virtual character falls, the NPC actively cares about the virtual character as a lover. Correspondingly, the server controls, based on the identity association relationship, the NPC to actively interact with the virtual character as an interaction initiator.

The computer device displays that the NPC transmits interactive content to the virtual character based on an interest identity indicated by the identity association relationship, the interactive content being one of a plurality of pieces of preset interactive content corresponding to the identity association relationship. Taking the mentoring relationship as an example, an interest identity of an NPC indicated by the mentoring relationship is an identity of master (teacher). The interactive content is one of a plurality of pieces of preset interactive content corresponding to the mentoring relationship. For example, a plurality of pieces of preset interactive content corresponding to the identity association relationship include teaching content of an identity of a master to an identity of an apprentice (student). For example, use of a virtual prop to attack an enemy character in the virtual environment is taught. Correspondingly, the server controls, based on the identity association relationship, the NPC to transmit, in an interest identity, the interactive content to the virtual character.

Further, the computer device displays that the interactive content transmitted by the NPC to the virtual character includes an identity appellation of the virtual character by the interest identity. Correspondingly, the server controls, based on the identity association relationship, the NPC to transmit, in an interest identity, the interactive content including an identity appellation of the interest identity for the virtual character to the virtual character.

For example, when that an identity association relationship between a virtual character and an NPC is a mentoring relationship, the virtual character is used as a master character, and the NPC is used as an apprentice character. Alternatively, the virtual character is used as an apprentice character, and the NPC is used as a master character. When the virtual character interacts with the NPC, identity appellations between the virtual character and the NPC change based on the identity association relationship.

In some embodiments, the computer device displays, in response to that a relationship between the NPC and the virtual character is a mentoring relationship, that the NPC transmits imperative interactive content to the virtual character as a master, where the imperative interactive content is interactive content includes directive information between superior-subordinate identity levels. The imperative interactive content is configuring for simulating directive information between a master and an apprentice in real life. For example, “Apprentice, go and fetch a pot of wine for me”.

In some embodiments, an NPC actively transmits comment content to a virtual character when that the virtual character wins in a battle. The comment content refers to evaluation content made by the NPC on action performance of the virtual character in a battle victory scenario, and the comment content is configured for displaying wonderful actions or wonderful images of the action performance of the virtual character in the battle victory scenario.

In some embodiments, an NPC actively transmits guidance content to a virtual character when that the virtual character fails in a battle. The guidance content refers to guiding content made by the NPC for action performance of the virtual character in a battle failure scenario. The guiding content is configuring for displaying shortcomings and areas for improvement in the action performance of the virtual character in the battle failure scenario. Alternatively, the guidance content refers to technical operation guidance content for passing through this battle match. Alternatively, the guidance content refers to skill content for quickly passing through this battle match. In some embodiments, the computer device displays, in response to that a relationship between the NPC and the virtual character is a lover relationship, that the NPC transmits communicative interactive content to the virtual character as a lover, where the communicative interactive content is interactive content including communicative information between same identity levels. The communicative interactive content is configured for simulating interactive content between two parties having equal postures in real life, for example, communication content between lovers.

In an exemplary implementation, the computer device is further configured to display that the NPC transmits interactive content containing historical interaction information to the virtual character. The historical interaction information refers to interactive content between the virtual character and the NPC before the identity association relationship is determined.

Correspondingly, the server obtains historical interaction information between the virtual character and the NPC; and controls the NPC to change interactive content between the NPC and the virtual character based on the identity association relationship and the historical interaction information.

The historical interaction information is obtained to simulate memory in real life, and interactive memory between the NPC and the virtual character is represented by the historical interaction information. For example, the virtual character and the NPC once talked about Xuanyuan City, and when talking about places where a tour is taken, the NPC offers to go to Xuanyuan City with the virtual character.

In an exemplary implementation, after the identity association relationship between the virtual character and the NPC is determined, in response to a selection operation on an interaction topic, it is displayed that the NPC transmits, to the virtual character, interest interactive content belonging to an interest topic selected by the selection operation.

The interaction topic refers to a discussible topic between the virtual character and the NPC.

In some embodiments, the interaction topic include at least one of a historical topic, a feelings topic, a social fun topic, a photography topic, and a geographical topic, but is not limited thereto. This is not specifically limited in the embodiment of this application. The function of the interaction topic is to control chat content between the virtual character and the NPC within a topic range, rather than talking in general terms. The virtual character may match a plurality of NPCs, each NPC corresponds to one identity association relationship, and a topic that the virtual character wants to talk about is selected after the identity association relationship is determined, so that the virtual character can progress layer by layer when interacting with the NPC, thereby improving intelligence of the NPC.

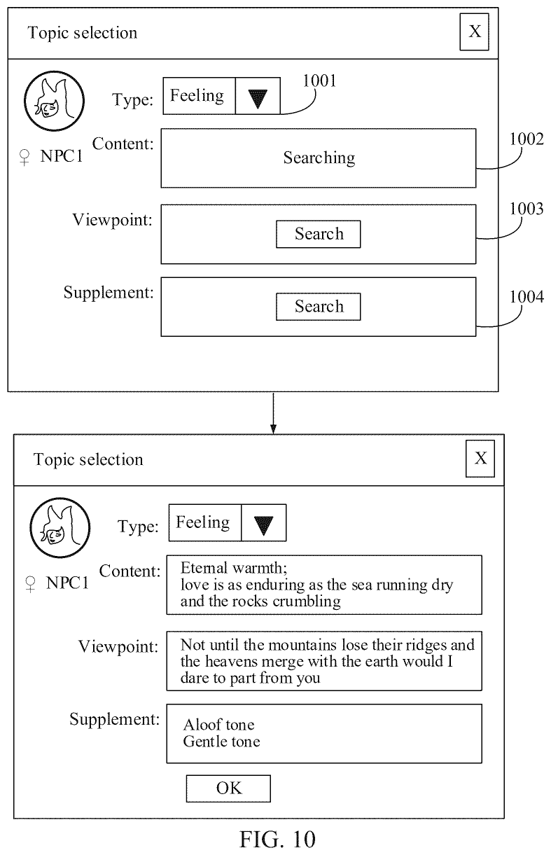

For example, FIG. 10 is a schematic diagram of an interface for selecting an interaction topic. When selecting an interaction topic between a virtual character and an NPC, a user first selects a topic type 1001, and a keyword of the topic type 1001 may be preset or may be inputted by the user. After the topic type 1001 is selected, “Searching” in the topic content 1002 is clicked to search for a topic, and the computer device generates 10 topics and displays the topics in the topic content 1002 to be selected by the user. For example, topic content displayed in the topic content 1002 is: “Eternal warmth” and “love is as enduring as the sea running dry and the rocks crumbling”. A search result is a one-time behavior, is recorded, and cannot be changed again. The user can only make a selection, and cannot search for the type again, but can change the type for searching. After selecting the topic content 1002, the user clicks “Search” in a topic viewpoint 1003 to search for a viewpoint. The computer device generates five viewpoints and displays the viewpoints in the topic viewpoint 1003 to be selected by the user. For example, the topic viewpoint displayed in the topic viewpoint 1003 is: “Not until the mountains lose their ridges and the heavens merge with the earth would I dare to part from you”. A search result is a one-time behavior, is recorded, and cannot be changed again. The user can only make a selection, and cannot search for the viewpoint again, but can change the topic viewpoint for searching. After selecting the topic viewpoint 1003, the user may supplement the topic in a topic supplement 1004 for the topic content 1002. For example, an interactive tone of the NPC may be supplemented as an aloof tone or gentle tone, but is not limited thereto. After all selections are made by the user, “OK” is clicked to complete selection of the interaction topic.

After the identity association relationship and the interaction topic between the virtual character and the NPC are determined, when the virtual character interacts with the NPC, the NPC modifies interactive content based on the identity association relationship and the interaction topic. For example, if there is a brotherly relationship between the virtual character and the NPC, the NPC cannot reply in terms of a mentoring relationship. The viewpoint and supplement in the interaction topic also affect the interactive content transmitted by NPC. For example, if the interaction topic is “What should I do when I am undecided?” and the topic viewpoint is “Make a prompt decision”, the NPC will no longer hesitate to reply in the future.

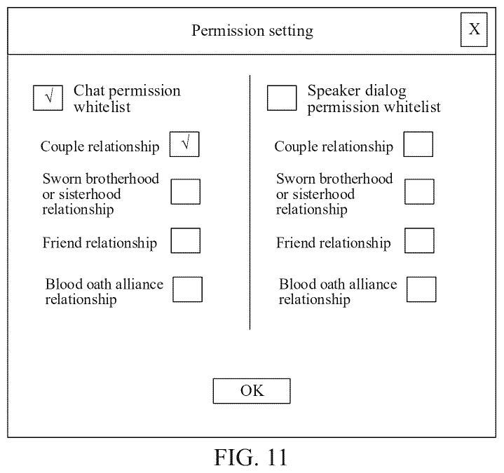

After the keyword is inputted, the computer device needs to add certain restrictive words to the keyword, so as to convert the keyword into an instruction that can be understood by the NPC. For example, if the inputted keyword is “Feelings”, an instruction that can be understood by the NPC is “Please provide 10 topics whose topic types are feelings”. In some embodiments, FIG. 11 is a schematic diagram of an interface for NPC interaction permission settings. An NPC having an identity association relationship with a virtual character may also interact with another virtual character, and the user may adjust an interaction permission between the NPC of the user and the another virtual character. The interaction permission includes a chat permission (private chat permission) and a speaker dialog permission whitelist (open dialog permission). The whitelist includes an identity association relationship corresponding to an NPC having an identity association relationship with a virtual character, and the NPC on the whitelist can interact with another virtual character.

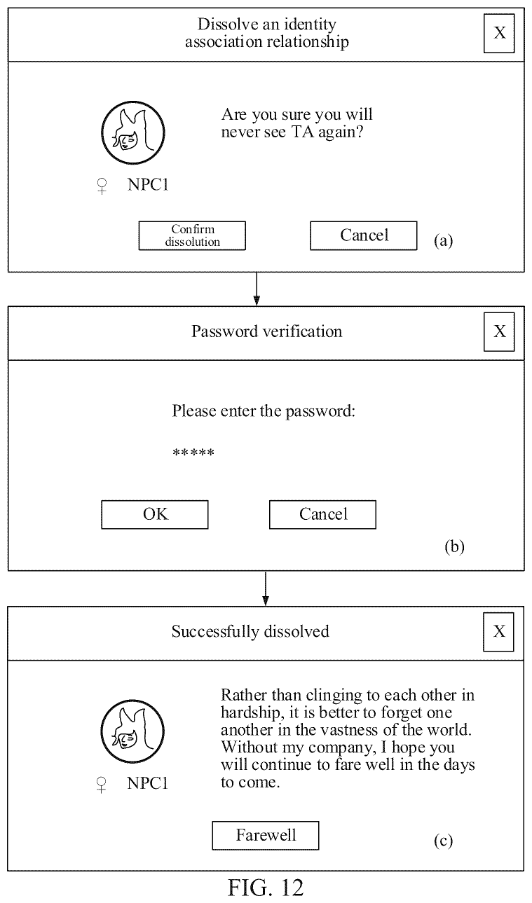

In some embodiments, FIG. 12 is a schematic diagram of an interface for dissolving an identity association relationship between a virtual character and an NPC. Identity association relationship dissolution prompt information is displayed when the identity association relationship between the virtual character and the NPC is dissolved, as shown in FIG. (a) in FIG. 12. After “Confirm dissolution” is clicked, a password input interface is displayed, as shown in FIG. (b) in FIG. 12. After a password is successfully entered, an interface indicating that the identity association relationship is successfully dissolved is displayed, as shown in FIG. (c) in FIG. 12.

To sum up, in the method according to this embodiment, in this application, at least one of an interactive mode and interactive content corresponding to the identity association relationship between the NPC and the virtual character is displayed, so that the NPC can change an interactive activity between the NPC and the virtual character based on the identity association relationship. This enriches the interactive activity between the NPC and the virtual character, so that a behavior of the NPC is closer to a virtual character controlled by a real user, thereby improving user experience.

In the method according to this embodiment, the interactive mode and/or the interactive content between the virtual character and the NPC is displayed, so that the NPC can actively interact with the virtual character. This enriches an interactive activity between the NPC and the virtual character, so that the behavior of the NPC is closer to a virtual character controlled by a real user, thereby improving user experience. In the method according to this embodiment, through historical interaction information between the virtual character and the NPC, interactive memory between the virtual character and the NPC is simulated, so that the behavior of the NPC is closer to a virtual character controlled by a real user, thereby improving user experience.

In the method according to this embodiment, an interaction topic between the virtual character and the NPC is selected, so that the virtual character and the NPC can interact in a more targeted mode during interaction, thereby avoiding talking in general terms. Therefore, the behavior of the NPC is closer to a virtual character controlled by a real user, thereby improving user experience. In the method according to this embodiment, the favorability value between the virtual character and the NPC is updated and displayed based on the interactive operation between the virtual character and the NPC, and the identity association relationship between the virtual character and the NPC is determined based on the favorability value. As the interaction degree is deeper, the relationship is closer, so that the behavior of the NPC is more real.

For example, in a method for interacting with a non-player character according to an exemplary embodiment of this application, in this solution, a new playing method in which a virtual character interacts with an NPC is provided in a strong social game ecology such as an MMORPG. A user may have a dialog and communicate with an NPC having an identity association relationship, or give a gift to the NPC to increase the favorability with the NPC, and then unlock interaction topic selection and the identity association relationship with the NPC. At first, the NPC only talks with a user in general terms about the world view, but with the increase of favorability, the tone and attitude of the NPC toward the user become increasingly friendly, and some topics and viewpoints under the topics may be further selected for in-depth exchange. In this case, the NPC no longer talks in general terms, but has a clear viewpoint on a specific thing and makes a statement around the viewpoint. As the favorability is increasingly high, an identity association may be established with the NPC. After an identity association is selected, an attitude of the NPC toward the virtual character changes based on this type of identity association relationship, and the user can further select a relationship/event supplement between the virtual character and the NPC, to increase “memory” between the user and the NPC. The memory changes chat content of the NPC with the user again. The identity association relationship may further bring active care from the NPC. For example, when the virtual character defeats or is upgraded, the NPC may transmit a comfort message, or transmit a congratulation gift to a player, and may further transmit a BUFF with an improved status. An AI model corresponding to the NPC may autonomously reply to a question corresponding to a player after learning a game world view. The reply of the AI model corresponding to the NPC needs certain restrictive words, so that the AI model can know how to play an NPC without being a goof. The favorability needs to be converted into an instruction that can be understood by AI, to affect a reply attitude of the AI. The reply of the AI further needs to be affected by effective emotional instructions, so that the AI can know an identity association relationship with the player, such as a brotherly relationship, and therefore the AI cannot reply in terms of a mentoring relationship. The player may select some topics and viewpoints for the AI to affect the reply of the AI. For example, if the interaction topic is “What should I do when I am undecided?” and the viewpoint is “Make a prompt decision”, the NPC will no longer hesitate to reply in the future. The player may add memory between the player and the AI to affect the reply of the AI. For example, if the player and the AI once went to Xuanyuan City, when the AI talks about a place where a tour is taken in the future, the AI takes the initiative to say that the AI wants to go to Xuanyuan City again with the player. All the above content affecting the reply of the AI is integrated into a voice of 4000 words that can be understood by the AI, and the voice is transmitted to the AI model. Since the AI model in the game is not trained by the player, but is standardized by the game through descriptions of the 4000 words, and is similar to a script of an actor, the AI needs to act based on the script. A composition keyword and a statement form of the 4000 words are the key, and all design requirements need to be included.

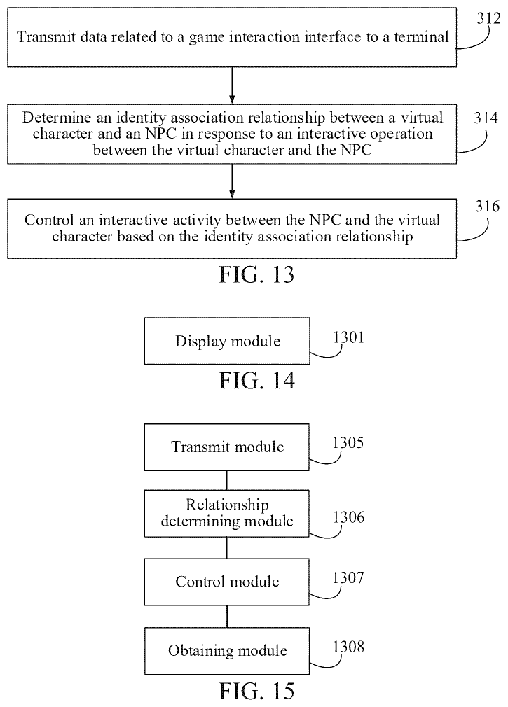

FIG. 13 is a flowchart of a method for performing interaction with a non-player character according to an exemplary embodiment of this application. The method may be performed by a server. The method includes the following operations:

Operation 312: Transmit data related to a game interaction interface to a terminal.

The game interaction interface includes a virtual character and at least one non-player character (NPC); and the game interaction interface refers to an interface through which a virtual character controlled by a user interacts with an NPC. For descriptions about the virtual character and the NPC, refer to operation 302 above. For example, the data transmitted by the server to the terminal may be at least one of instruction information, a multimedia material, a video stream, and an audio stream. In an example, a game to which a game interaction image belongs is a game application, and the data transmitted by the server to the terminal is instruction information, to indicate the terminal to display the game interaction image. Further, a multimedia material in the game interaction interface is stored by the terminal, and indication information is configured for indicating the multimedia material that needs to be invoked by the terminal to display the game interaction image, and/or a mode in which the multimedia material displays the game interaction image in a rendered mode (for example, a location of the multimedia material in the game interaction image). In another example, the game to which the game interaction image belongs is a web game, the data transmitted by the server to the terminal includes a multimedia material, and the terminal displays the game interaction image in a rendered mode based on the multimedia material provided by the server. In another example, the game to which the game interaction image belongs is a cloud game, and the cloud game runs on the server. The server renders a video stream of the cloud game, and the terminal receives and displays the video stream transmitted by the server. The video stream carries audio information, that is, includes an audio stream.

Operation 314: Determine an identity association relationship between the virtual character and the NPC in response to an interactive operation between the virtual character and the NPC.

For example, the interactive operation may be an operation of unidirectional or bidirectional communication between the virtual character and the NPC; and the identity association relationship is configured for indicating an association relationship between the virtual character and the NPC in terms of interactive identity. In some embodiments, the identity association relationship includes at least one of a lover relationship, a confidant relationship, a playmate relationship, and a mentoring relationship, but is not limited thereto. This is not specifically limited in the embodiment of this application.

For example, the identity association relationship displayed by the terminal is displayed based on an indication of the server. For example, the server transmits indication information to the terminal, to indicate the terminal to display the identity association relationship. The indication information carries the identity association relationship needing to be displayed.

Operation 316: Control an interactive activity between the NPC and the virtual character based on the identity association relationship.

The interactive activity is an interaction behavior between the NPC and the virtual character, and the interactive activity may be initiated by either of the NPC and the virtual character. The interactive activity may be that either of the NPC or the virtual character transmits information to the other party unidirectionally, or both parties may transfer information to each other. In an exemplary implementation, operation 316 may be implemented as the following: controlling at least one of an interactive mode and interactive content between the NPC and the virtual character based on the identity association relationship.

The interactive mode is an initiating form when the virtual character interacts with the NPC, for example, which one serves as an interaction initiator during interaction. The interactive mode refers to an interaction form when the virtual character interacts with the NPC, and the interaction form includes at least one of text interaction, voice interaction, and emoji interaction, but is not limited thereto.

The interactive content is content when the virtual character interacts with the NPC. In some embodiments, the interactive content includes at least one of an identity appellation, a modal particle, an active sentence, a passive sentence, and a topic range, but is not limited thereto.

In another exemplary implementation, the method further includes the following operations: obtaining historical interaction information between the virtual character and the NPC, the historical interaction information referring to interactive content between the virtual character and the NPC before the identity association relationship is determined;
controlling the NPC to change interactive content between the NPC and the virtual character based on the identity association relationship and the historical interaction information; and
obtaining the historical interaction information to simulate memory in real life, interactive memory between the NPC and the virtual character being represented by the historical interaction information.

To sum up, in the method according to this embodiment, in this application, the identity association relationship between the virtual character and the NPC is determined, so that the NPC can control an interactive activity between the NPC and the virtual character based on the identity association relationship, and the interactive activity between the NPC and the virtual character is richer and more real. Therefore, a behavior of the NPC is closer to a virtual character controlled by a real user, thereby improving user experience.

FIG. 14 is a schematic structural diagram of an apparatus for interaction with a non-player character according to an exemplary embodiment of this application. The apparatus may be implemented as all or a part of a computer device through software, hardware, or a combination thereof. The apparatus includes:
a display module 1301, configured to display a game interaction interface, the game interaction interface including a virtual character and at least one non-player character (NPC);
the display module 1301 being further configured to display an identity association relationship between the virtual character and the NPC in response to an interactive operation between the virtual character and the NPC; the identity association relationship being configured for indicating an association relationship between the virtual character and the NPC in terms of interactive identity; and
the display module 1301 being further configured to display an interactive activity between the NPC and the virtual character based on the identity association relationship.

In some embodiments, the display module 1301 is configured to display at least one of an interactive mode and interactive content between the NPC and the virtual character based on the identity association relationship.

In some embodiments, the display module 1301 is configured to display that the NPC actively interacts with the virtual character as an interaction initiator.

In some embodiments, the display module 1301 is configured to display that the NPC transmits interactive content to the virtual character based on an interest identity indicated by the identity association relationship, the interactive content being one of a plurality of pieces of preset interactive content corresponding to the identity association relationship.

In some embodiments, the display module 1301 is configured to display that the interactive content transmitted by the NPC to the virtual character includes an identity appellation of the virtual character by the interest identity.

In some embodiments, the display module 1301 is configured to display, in response to that a relationship between the NPC and the virtual character is a mentoring relationship, that the NPC transmits imperative interactive content to the virtual character as a master.

The imperative interactive content is interactive content including directive information between superior-subordinate identity levels.

In some embodiments, the display module 1301 is configured to display, in response to that a relationship between the NPC and the virtual character is a lover relationship, that the NPC transmits communicative interactive content to the virtual character as a lover.

The communicative interactive content is interactive content including communicative information between same identity levels.

In some embodiments, the display module 1301 is configured to display that the NPC transmits the interactive content including historical interaction information to the virtual character, the historical interaction information referring to interactive content between the virtual character and the NPC before the identity association relationship is determined.

In some embodiments, the display module 1301 is configured to display, in response to a selection operation on an interaction topic, that the NPC transmits, to the virtual character, interest interactive content belonging to an interest topic selected by the selection operation.

In some embodiments, the display module 1301 is configured to update and display a favorability value between the virtual character and the NPC based on the interactive operation; and display the identity association relationship between the virtual character and the NPC corresponding to the favorability value.

FIG. 15 is a schematic structural diagram of an apparatus for interaction with a non-player character according to an exemplary embodiment of this application. The apparatus may be implemented as all or a part of a computer device by software, hardware, or a combination of software and hardware. The apparatus includes:
a transmit module 1305, configured to transmit data related to a game interaction interface to a terminal, the game interaction interface including a virtual character and at least one non-player character (NPC);
a relationship determining module 1306, configured to determine an identity association relationship between the virtual character and the NPC based on an interactive operation between the virtual character and the NPC, the identity association relationship being configured for indicating an association relationship between the virtual character and the NPC in terms of interactive identity; and
a control module 1307, configured to control an interactive activity between the NPC and the virtual character based on the identity association relationship.

In some embodiments, the control module 1307 is configured to control at least one of an interactive mode and interactive content between the NPC and the virtual character based on the identity association relationship.

In some embodiments, the apparatus further includes: an obtaining module 1308, configured to obtain historical interaction information between the virtual character and the NPC, the historical interaction information referring to interactive content between the virtual character and the NPC before the identity association relationship is determined; and a control module 1307, configured to control the NPC to change interactive content between the NPC and the virtual character based on the identity association relationship and the historical interaction information.

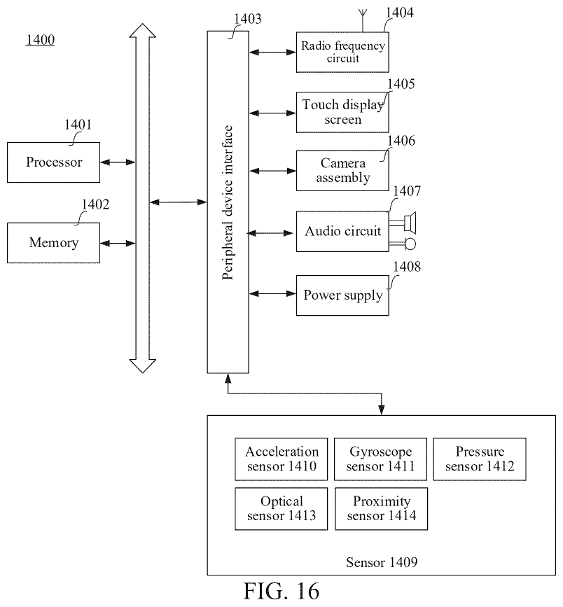

FIG. 16 is a structural block diagram of a computer device 1400 according to an exemplary embodiment of this application. The computer device 1400 may be a portable mobile terminal, such as a smartphone, a tablet computer, a moving picture experts group audio layer III (MP3) player, or a moving picture experts group audio layer IV (MP4) player. The computer device 1400 may also be referred to as a user device, a portable terminal, or the like

Generally, the computer device 1400 includes a processor 1401 and a memory 1402.

The processor 1401 may include one or more processing cores, for example, a 4-core processor or an 8-core processor. The processor 1401 may be implemented in at least one hardware form of digital signal processing (DSP), a field-programmable gate array (FPGA), and a programmable logic array (PLA). The processor 1401 may alternatively include a main processor and a coprocessor, and the main processor is a processor configured to process data in a wake-up state, also referred to as a central processing unit (CPU). The coprocessor is a low-power processor configured to process data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more computer-readable storage mediums. The computer-readable storage medium may be tangible and non-transitory. The memory 1402 may further include a high-speed random access memory and a nonvolatile memory, for example, one or more disk storage devices or flash storage devices. In some embodiments, the non-transitory computer-readable storage medium in the memory 1402 is configured to store at least one instruction, and the at least one instruction is configured for being executed by the processor 1401 to implement a method for display a virtual environment image in the embodiment of this application. In some embodiments, the computer device 1400 may alternatively include a peripheral device interface 1403 and at least one peripheral device. Specifically, the peripheral device includes at least one of a radio frequency circuit 1404, a touch display screen 1405, a camera assembly 1406, an audio circuit 1407, and a power supply 1408.

The peripheral device interface 1403 may be configured to connect the at least one peripheral device related to input/output (I/O) to the processor 1401 and the memory 1402. In some embodiments, the processor 1401, the memory 1402, and the peripheral device interface 1403 are integrated on the same chip or circuit board. In some other embodiments, any one or two of the processor 1401, the memory 1402, and the peripheral device interface 1403 may be implemented on an independent chip or circuit board. This is not limited in this embodiment.

The radio frequency circuit 1404 is configured to receive and transmit a radio frequency (RF) signal, which is also referred to as an electromagnetic signal. The radio frequency circuit 1404 communicates with a communication network and other communication devices through the electromagnetic signal. The touch display screen 1405 is configured to display a user interface (UI). The UI may include a graph, text, an icon, a video, and any combination thereof. The camera assembly 1406 is configured to collect an image or a video. In some embodiments, the camera assembly 1406 includes a front camera and a rear camera. The audio circuit 1407 is configured to provide an audio interface between the user and the computer device 1400. The audio circuit 1407 may include a microphone and a speaker. The microphone is configured to collect sound waves of a user and an environment, and convert the sound waves into an electrical signal to input to the processor 1401 for processing, or input to the radio frequency circuit 1404 to implement voice communication. The power supply 1408 is configured to supply power to assemblies in the computer device 1400. The power supply 1408 may be an alternating current, a direct current, a primary battery, or a rechargeable battery. In some embodiments, the computer device 1400 further includes one or more sensors 1409. The one or more sensors 1409 include, but are not limited to: an acceleration sensor 1410, a gyroscope sensor 1411, a pressure sensor 1412, an optical sensor 1413, and a proximity sensor 1414. The acceleration sensor 1410 may detect a magnitude of acceleration on three coordinate axes of a coordinate system established with the computer device 1400. The gyroscope sensor 1411 may detect a body direction and a rotation angle of the computer device 1400. The gyroscope sensor 1411 may cooperate with the acceleration sensor 1410 to collect a three-dimensional (3D) action by the user on the computer device 1400. The pressure sensor 1412 may be disposed at a side frame of the computer device 1400 and/or a lower layer of the touch display screen 1405. The pressure sensor detects a signal of holding the computer device 1400 by a user, and/or controls an operable control on the UI based on a pressure operation by the user on the touch display screen 1405. The optical sensor 1413 is configured to collect an ambient light intensity. The proximity sensor 1414, also referred to as a distance sensor, is generally disposed on a front surface of the computer device 1400. The proximity sensor 1414 is configured to collect a distance between the user and the front surface of the computer device 1400. A person skilled in the art may understand that the structure shown in FIG. 14 does not constitute a limitation on the computer device 1400, and the computer device may include more or fewer assemblies than those shown in the figure, or combine some assemblies, or use different assembly arrangements.

An embodiment of this application further provides a computer device, including a processor and a memory, the memory having at least one computer program stored therein, and the at least one computer program being loaded and executed by the processor to implement the method for performing interaction with a non-player character according to the foregoing method embodiments.

An embodiment of this application further provides a computer-readable storage medium, the storage medium storing at least one computer program therein, and the at least one computer program being loaded and executed by a processor to implement the method for performing interaction with a non-player character according to the foregoing method embodiments.

An embodiment of this application further provides a computer program product, the computer program product including a computer program, and the computer program being stored in a computer-readable storage medium; and a processor of a computer device reading the computer program from the computer-readable storage medium and executing the computer program, to cause the computer device to perform and implement the method for performing interaction with a non-player character according to the foregoing method embodiments.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. In the specific implementation of this application, there is the data involved, historical data, portraits, and other data processing relevant data related to user identities or characteristics. When the foregoing embodiments of this application are applied to a specific product or technology, a permission or consent of a user needs to be obtained. Collection, use, and processing of relevant data need to comply with relevant laws, regulations and standards of relevant countries and regions.

What is claimed is:

1. A method for performing interaction with a non-player character performed by a computer device, the method comprising:
displaying a game interaction interface, the game interaction interface including a virtual character and at least one non-player character (NPC);
determining an identity association relationship between the virtual character and the NPC in response to an interactive operation between the virtual character and the NPC; and
displaying an interactive activity between the NPC and the virtual character based on the identity association relationship.

2. The method according to claim 1, wherein the displaying an interactive activity between the NPC and the virtual character based on the identity association relationship comprises:
displaying at least one of an interactive mode and interactive content between the NPC and the virtual character based on the identity association relationship.

3. The method according to claim 2, wherein the displaying an interactive mode between the NPC and the virtual character based on the identity association relationship comprises:
displaying that the NPC actively interacts with the virtual character as an interaction initiator.

4. The method according to claim 2, wherein the displaying interactive content between the NPC and the virtual character based on the identity association relationship comprises:
displaying that the NPC transmits the interactive content to the virtual character based on an interest identity indicated by the identity association relationship, the interactive content being one of a plurality of pieces of preset interactive content corresponding to the identity association relationship.

5. The method according to claim 1, wherein the method further comprises:
displaying that the NPC transmits the interactive content comprising historical interaction information to the virtual character, the historical interaction information referring to interactive content between the virtual character and the NPC before the identity association relationship is determined.

6. The method according to claim 1, wherein the method further comprises:
displaying, in response to a selection operation on an interaction topic, that the NPC transmits, to the virtual character, interest interactive content belonging to an interest topic selected by the selection operation.

7. The method according to claim 1, wherein the determining an identity association relationship between the virtual character and the NPC in response to an interactive operation between the virtual character and the NPC comprises:
determining a favorability value between the virtual character and the NPC based on the interactive operation; and
determining the identity association relationship between the virtual character and the NPC corresponding to the favorability value.

8. A computer device, comprising: a processor and a memory, the memory having at least one computer program stored therein, and the at least one computer program, when loaded and executed by the processor, causing the computer device to implement a method for performing interaction with a non-player character including:
displaying a game interaction interface, the game interaction interface including a virtual character and at least one non-player character (NPC);
determining an identity association relationship between the virtual character and the NPC in response to an interactive operation between the virtual character and the NPC; and
displaying an interactive activity between the NPC and the virtual character based on the identity association relationship.

9. The computer device according to claim 8, wherein the displaying an interactive activity between the NPC and the virtual character based on the identity association relationship comprises:
displaying at least one of an interactive mode and interactive content between the NPC and the virtual character based on the identity association relationship.

10. The computer device according to claim 9, wherein the displaying an interactive mode between the NPC and the virtual character based on the identity association relationship comprises:
displaying that the NPC actively interacts with the virtual character as an interaction initiator.

11. The computer device according to claim 9, wherein the displaying interactive content between the NPC and the virtual character based on the identity association relationship comprises:
displaying that the NPC transmits the interactive content to the virtual character based on an interest identity indicated by the identity association relationship, the interactive content being one of a plurality of pieces of preset interactive content corresponding to the identity association relationship.

12. The computer device according to claim 8, wherein the method further comprises:
displaying that the NPC transmits the interactive content comprising historical interaction information to the virtual character, the historical interaction information referring to interactive content between the virtual character and the NPC before the identity association relationship is determined.

13. The computer device according to claim 8, wherein the method further comprises:
displaying, in response to a selection operation on an interaction topic, that the NPC transmits, to the virtual character, interest interactive content belonging to an interest topic selected by the selection operation.

14. The computer device according to claim 8, wherein the determining an identity association relationship between the virtual character and the NPC in response to an interactive operation between the virtual character and the NPC comprises:
determining a favorability value between the virtual character and the NPC based on the interactive operation; and
determining the identity association relationship between the virtual character and the NPC corresponding to the favorability value.

15. A non-transitory computer storage medium having at least one computer program stored therein, and the at least one computer program, when loaded and executed by a processor of a computer device, causing the computer device to implement a method for performing interaction with a non-player character including:
displaying a game interaction interface, the game interaction interface including a virtual character and at least one non-player character (NPC);
determining an identity association relationship between the virtual character and the NPC in response to an interactive operation between the virtual character and the NPC; and
displaying an interactive activity between the NPC and the virtual character based on the identity association relationship.

16. The non-transitory computer storage medium according to claim 15, wherein the displaying an interactive activity between the NPC and the virtual character based on the identity association relationship comprises:
displaying at least one of an interactive mode and interactive content between the NPC and the virtual character based on the identity association relationship.

17. The non-transitory computer storage medium according to claim 16, wherein the displaying interactive content between the NPC and the virtual character based on the identity association relationship comprises:
displaying that the NPC transmits the interactive content to the virtual character based on an interest identity indicated by the identity association relationship, the interactive content being one of a plurality of pieces of preset interactive content corresponding to the identity association relationship.

18. The non-transitory computer storage medium according to claim 15, wherein the method further comprises:
displaying that the NPC transmits the interactive content comprising historical interaction information to the virtual character, the historical interaction information referring to interactive content between the virtual character and the NPC before the identity association relationship is determined.

19. The non-transitory computer storage medium according to claim 15, wherein the method further comprises:
displaying, in response to a selection operation on an interaction topic, that the NPC transmits, to the virtual character, interest interactive content belonging to an interest topic selected by the selection operation.

20. The non-transitory computer storage medium according to claim 15, wherein the determining an identity association relationship between the virtual character and the NPC in response to an interactive operation between the virtual character and the NPC comprises:
determining a favorability value between the virtual character and the NPC based on the interactive operation; and
determining the identity association relationship between the virtual character and the NPC corresponding to the favorability value.
